(19) United States
(12) Patent Application Publication
(10) Pub. No.: US 2016/0018099 A1
(43) Pub. Date: Jan. 21, 2016

(54) ILLUMINATING DEVICE FOR A HOUSEHOLD APPLIANCE AND HOUSEHOLD APPLIANCE WITH SUCH AN ILLUMINATING DEVICE

(71) Applicant: BSH HAUSGERÄTE GMBH, Muenchen (DE)

(72) Inventors: ALPER ERDEM, ULM (DE); ALI EKBER SENGER, ISTANBUL (TR); MEHMET SEVAL, ISTANBUL (TR)

(21) Appl. No.: 14/773,479

(22) PCT Filed: Feb. 24, 2014
(86) PCT No.: PCT/EP2014/053542

§ 371 Date: Sep. 8, 2015

(30) Foreign Application Priority Data
Mar. 8, 2013 (TR) 2013/02850

(51) Int. Cl. F21V 33/00; F25D 27/00; F21V 23/06; F21V 21/08; F21V 21/088

(52) U.S. Cl. CPC F21V 33/0044; F21V 21/08; F21V 21/088; F21V 23/06; F25D 27/00; F21W 2131/30

(57) ABSTRACT

An illuminating device for a household appliance, with a wall of the household appliance, and a circuit board with at least one light source. The circuit board is arranged on a carrier, which is formed as a fixing adapter for the circuit board on the wall. The invention also relates to a household appliance with an illuminating device.

The invention relates to an illuminating device for a household appliance, with a wall of the household appliance. The illuminating device moreover comprises a circuit board or a circuit board carrier with at least one light source. The invention further relates to a household appliance with at least one such illuminating device.

Household appliances, which are, for example, provided for the preparation of food or for the storage and conservation of food, usually comprise a receiving space for the food. Such a receiving space or interior is illuminated, when a door, which closes the interior, is opened. This is, for example, the case with domestic cooling appliances, such as a refrigerator or a freezer or a fridge-freezer. Light sources can here be positioned laterally or in the rear region of the interior, which is defined by the walls of an inner container. With the known embodiments usually a relatively large light source is used, which also extends far into the interior, so that the capacity there of the usable volume is reduced.

It is the object of the present invention to provide an illuminating device as well as a household appliance with such an illuminating device, which is compact and requires a reduced mounting effort.

The object is solved by an illuminating device and a household appliance according to the independent claims.

An illuminating device for a household appliance according to the invention comprises a wall of the household appliance. The illuminating device moreover has an electronic circuit board with at least one light source. An essential idea of the invention is to be seen in that the circuit board is arranged on a carrier, which is formed as a fixing adapter for the circuit board on the wall. Such a separate component is thus formed multifunctional. It enables besides a mechanically stable reception of the circuit board a simple and yet safe and reliable assembly. Moreover, by means of a carrier having a very flat design also a compact and space-saving illuminating device can be created, with which the usable volume of an interior of the household appliance, which can be illuminated by the illuminating device, is not impaired.

It is preferably provided that the carrier is non-destructively detachably connected with the wall. Such an embodiment is particularly advantageous, since thus an assembly and disassembly can be repeatably performed. Specifically for maintenance and replacement purposes this embodiment is thus particularly advantageous.

Moreover, such a fixing adapter allows for the positioning and mounting of a circuit board with at least one light source in places, where this has not yet been possible, since by means of the fixing adapter mechanical coupling also to diverse components is enabled. Even if, for example, fastening points are spaced far apart or positioned such that the circuit board alone cannot be held in at least two places, this is now possible without problems by means of such a fixing adapter.

It is preferably provided that the carrier has a base body, on which on opposing sides retaining arms with engagement slots for the engagement of retaining brackets of the wall are formed. The retaining arms in particular protrude laterally to the outside in opposite directions, but in a straight line with each other. Here, positionally as well as functionally a concept is enabled, by means of which a very exact positioning, which can also be held permanently, is achieved, and by means of which the mechanical coupling and thus mounting can be performed easily. Particularly the mechanical couplings of very thin and flatly expanded retaining brackets into such engagement slots considerably reinforce the aforementioned advantages.

It is preferably provided that the carrier has a base body, on which on a longitudinal side two support arms which are spaced apart and oriented parallel to each other are formed, which are provided for supporting the circuit board. Objectively, thus besides the retaining arms preferably in addition further support arms are provided, which are functionally formed for different applications. Also the circuit board is thus held position-fixed.

Preferably the support arms are positioned parallel to and spaced apart from each other. In particular, the orientation of the support arms is perpendicular to the retaining arms. In particular, the support arms and the retaining arms are arranged in star shape.

It is preferably provided that the support arms have clasping elements, which engage around an edge of the circuit board. The positional restraint is thus again improved.

It is preferably provided that the carrier has a base body, on which a holding device for a contact connector for electrically connecting an electrical line with electrical contacts of the circuit board is formed. The carrier can thus receive and hold a plurality of separate components. Precisely such a separate contact connector is thus also positioned mechanically stable and can be coupled with a further connector part with the line.

It is preferably provided that the holding device comprises a receiving body, into which the contact connector can be inserted, and at least one fixing element for position fixing of the contact connector. Thereby the contact connector, when arranged in its end position, is arranged on the carrier especially in all three spatial directions in a slip-tight manner.

It is preferably provided that the fixing element is a ramp, over which the contact connector can be pushed into its end position and which engages behind the contact connector in the end position. By means of such an embodiment, a simple mounting scenario is enabled and yet a reliable and mechanically stable fixation of the end position of the contact connector achieved.

It is preferably provided that the holding device has release yokes, with which the fixing element is movable downwards from the fixing position and movable into a release position, so that the contact connector can be removed. This is also a very simple and user-friendly embodiment so as to be able to achieve a disassembly easily and quickly.

It is preferably provided that the carrier has a base body, which has an insertion slot for receiving a retaining bracket of the wall. In particular, the insertion slot is located on a third side of the carrier, wherein on the other two sides the retaining arms are formed. Thereby, a further improvement of the positional arrangement of the carrier on the wall is achieved.

It is preferably provided that behind the insertion slot the base body has an opening accessible from above, through which a fastening element, in particular a screw, is insertable and movable into a receptacle in the retaining bracket. The position fixing is thus again improved and the fastening element in the mounted state also, as it were, sunk and concealed.

It is preferably provided that the carrier is formed in one piece and made of plastic. As a material, for example, PBT (polybutylene terephthalate) can be used.

It is particularly provided that at least one light source is a light-emitting diode. Since particularly light-emitting diodes can be operated very energy-efficiently, and besides are very compact, it is now also possible with the carrier as a fixing adapter to position such small light sources in places, which otherwise cannot be envisaged for this purpose. Specifically, if the wall due to its construction has retaining points which are spaced far apart and/or larger recesses, the fastening of such circuit boards with light-emitting diodes has not been possible so far. This is now possible by means of such an adapter.

It is particularly provided that a household appliance according to the invention is formed as a domestic cooling appliance. The household appliance in particular comprises an interior for receiving foodstuffs and at least one illuminating device according to the invention or an advantageous embodiment thereof, which is arranged so as to illuminate the interior.

It is particularly advantageous if this wall is a top wall, which delimits the interior. Thus, illumination of the interior can take place from above so that an illumination, which is very powerful and as extensive as possible, is rendered possible. This is ensured even if the interior is filled with plenty of food.

Further features of the invention are apparent from the claims, the figures and the description of the figures. The features and feature combinations previously mentioned in the description and the features and feature combinations mentioned below in the description of the figures and/or shown in the figures alone are usable not only in the respectively specified combination, but also in other combinations or else alone, without leaving the scope of the invention. Thus, also embodiments are to be regarded as comprised and disclosed by the invention, which are not explicitly shown and explained by the figures, but which derive and are producible from the illustrated explanations by separated feature combinations.

Embodiments of the invention are detailed below with reference to schematic drawings. Therein show:

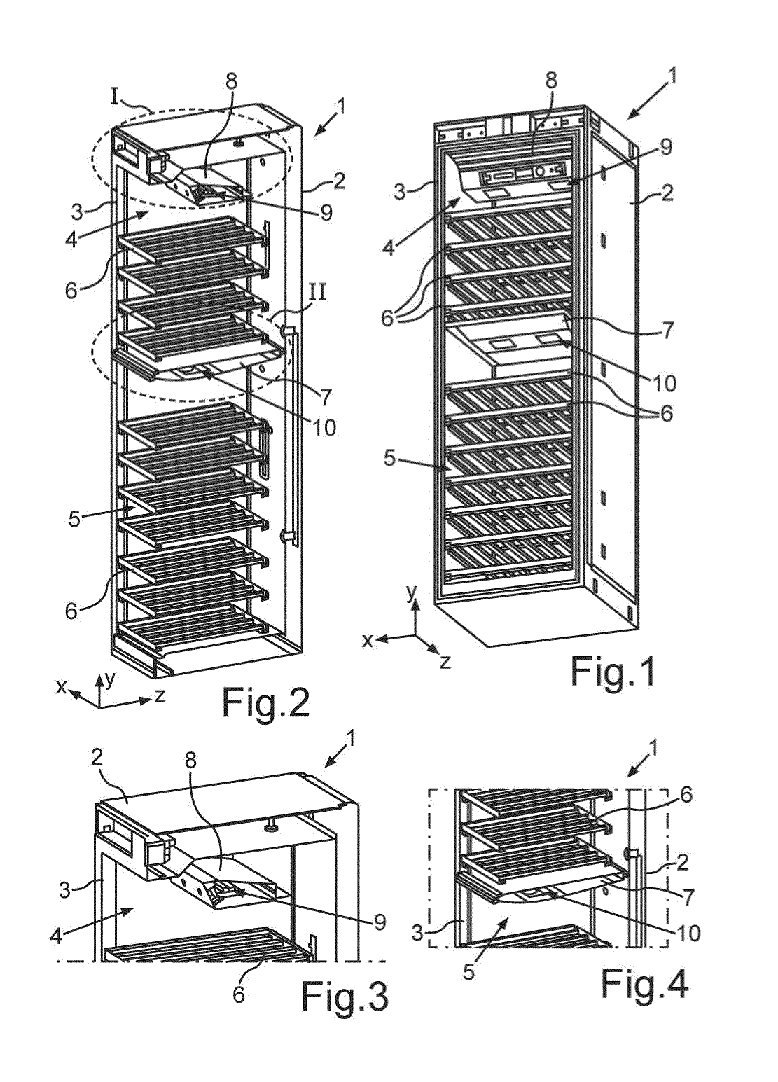

FIG. 1 a perspective view of an embodiment of a household appliance according to the invention;

FIG. 2 a perspective sectional view of the household appliance according to FIG. 1;

FIG. 3 an enlarged view of a part of the illustration in FIG. 2;

FIG. 4 a further partial view of the embodiment of FIG. 2;

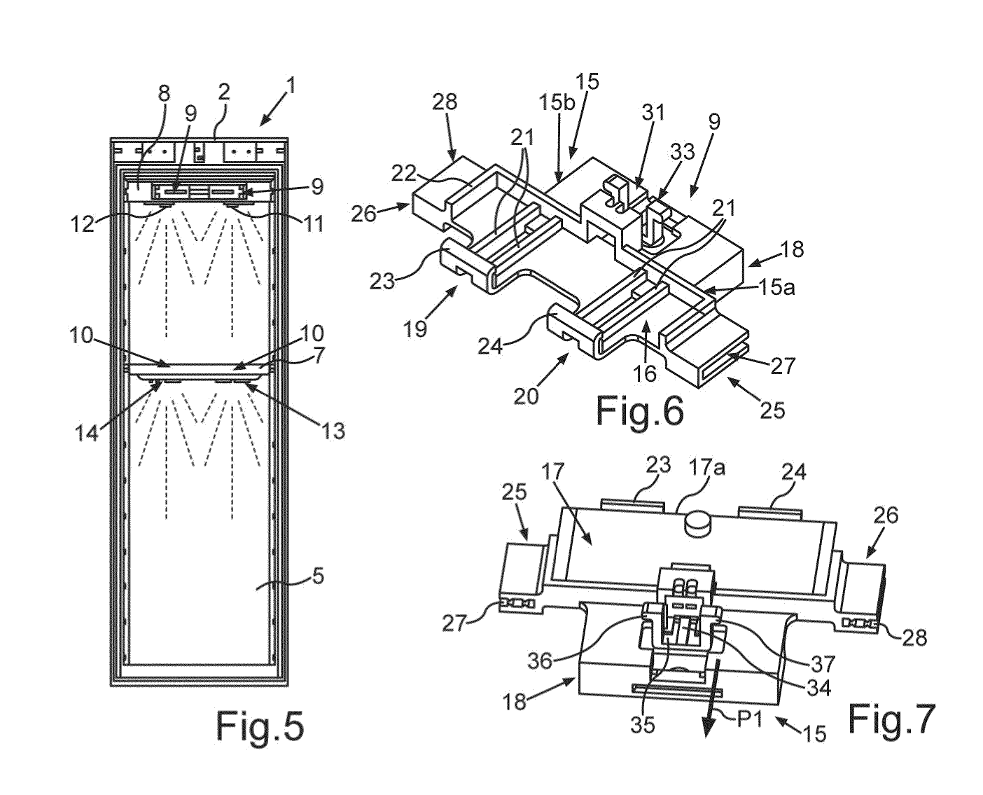

FIG. 5 a front view of the household appliance according to FIG. 1 and FIG. 2 with illustrated illumination scenarios;

FIG. 6 a perspective view of an embodiment of a carrier of an illuminating device according to the invention;

FIG. 7 a further perspective view of the carrier according to FIG. 6;

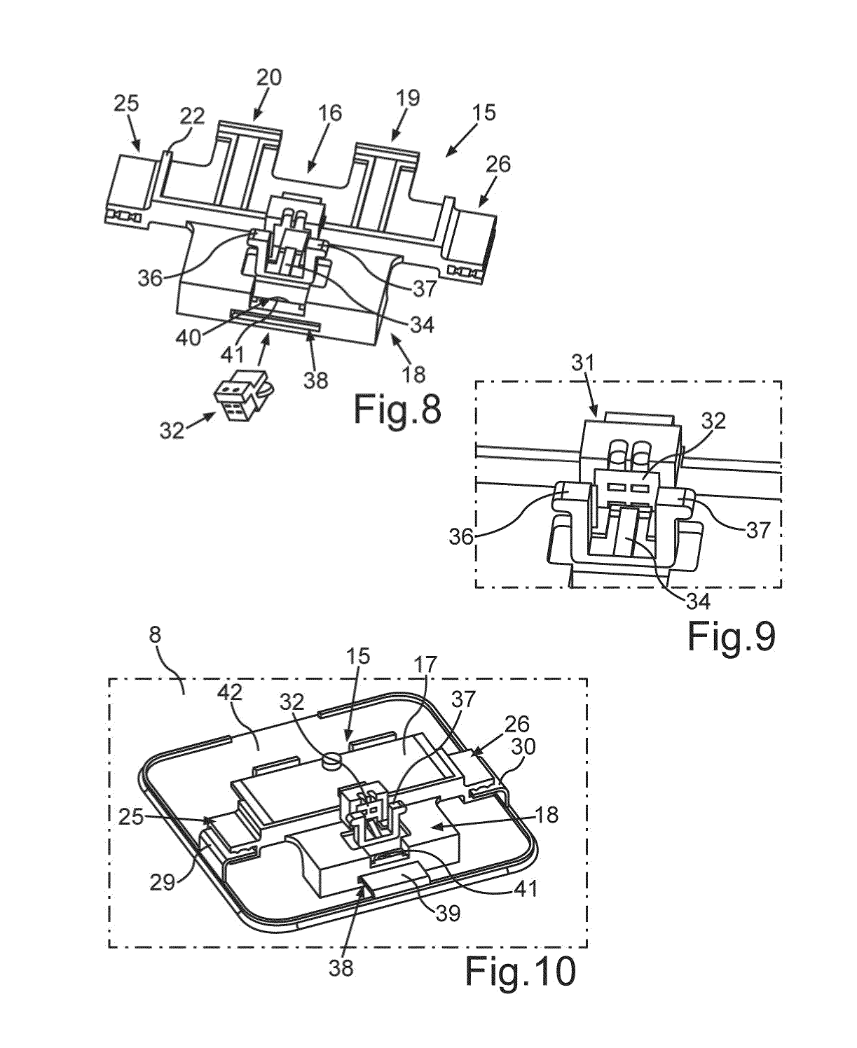

FIG. 8 a further perspective view of a carrier according to FIG. 6 and FIG. 7 with a contact connector illustrated separately thereto;

FIG. 9 a perspective view of the embodiment of FIG. 8 with mounted contact connector; and

FIG. 10 a perspective view of an embodiment of an illuminating device according to the invention.

In the figures identical or functionally identical elements bear the same reference numbers.

FIG. 1 shows in a perspective view a household appliance 1, which is a domestic cooling appliance. The household appliance 1 can, for example, be a refrigerator or a freezer or a fridge-freezer. The household appliance 1 comprises an outer housing 2, which defines an inner container 3. The inner container 3 has in the embodiment two separate inner spaces 4 and 5, in which by way of example a plurality of dividers 6 are positioned. The two inner spaces 4 and 5 are separated by a partition wall 7. Foodstuffs such as, for example, drinks and dishes can be placed in the inner spaces 4 and 5 for cooling and storage.

The upper inner space 4 is defined by a top wall 8. In this top wall 8 at least one illuminating device 9 is positioned, which is configured to illuminate the inner space 4 from above.

Besides, in the partition wall 7, which forms a top wall for the lower inner space 5, also at least one illuminating device 10 is positioned, which is configured to illuminate the inner space 5 from above.

FIG. 2 shows a perspective sectional view with a sectional plane in the y-z-plane of the household appliance 1.

In FIG. 3 in an enlarged view the area I of FIG. 2 is shown. The embodiment of the top wall 8 with the at least one, preferably a plurality of, illuminating devices 9 is shown.

In FIG. 4 an enlarged view of the partial area II of FIG. 2 is shown.

In FIG. 5 a front view of the household appliance 1 is shown, wherein here as well as in FIGS. 1 to 4 a door closing the inner spaces 4 and 5 is not shown. In FIG. 5 a view is shown, in which the illuminating devices 9 and 10 are activated so that light sources 11, 12, 13, and 14 illuminate the respective inner spaces 4 and 5 from above.

For fastening such an illuminating device 9, specific components are provided, which are explained in more detail below. The explanations in this respect also apply to an illuminating device 10.

As shown in FIG. 6, the illuminating device 9 comprises besides the wall 8 a carrier 15, which is formed in one piece of plastic, for example PBT. The carrier 15 comprises a receiving space 16, in which a circuit board 17 (FIG. 7 and FIG. 10) is received.

The carrier 15, which also constitutes a fixing adapter for the circuit board 17 on the wall 8, comprises a base body 18, to which the receiving space 16 is formed. On the base body 18 also two support arms 19 and 20 are formed, which are provided for receiving the circuit board 17. Since the carrier 15 is formed very flat, it is formed to require a minimum of material and comprises in the receiving space 16 mechanical stiffening struts 21.

Besides, a U-shaped edge limitation 22 is provided, which, accordingly, supports the circuit board 17 at the sides. At cantilevering ends of the support arms 19 and 20 clasping elements 23 and 24 are formed. Said clasping elements 23 and 24 may be elastic, if need be, so that they engage around a side edge 17a (FIG. 7) of the circuit board 17. This is shown in FIG. 7, in which the mounted end position of the circuit board 17 on the carrier 15 is illustrated.

Laterally to the receiving space 16 on opposing sides 15a, 15b of the carrier 15 retaining arms 25 and 26 are formed. The retaining arms 25 and 26 have engagement slots 27 and 28, which are provided for the engagement of retaining brackets 29 and 30 (FIG. 10). These retaining brackets 29 and 30 are formed to the wall 8 in one piece and are of angular form. The retaining brackets 29 and 30 also have cantilevering plate-like end elements, which are then in the mounted end position of the carrier 15 on the wall 8, which is shown in FIG. 10, positioned in the engagement slots 27 and 28.

As can moreover be seen from the illustration in FIG. 6, on the base body 18 also a holding device 31 for a separate electrical contact connector 32 (FIG. 8) formed. The contact connector 32 is provided for electrically connecting a further connector part, which has an electrical line, with electrical contacts of the circuit board 17.

The holding device 31 comprises a receiving body, into which the contact connector 32 is insertable. Besides, the holding device 31 also comprises a fixing element 34 (FIG. 7), which is formed as a ramp inclined upwards relative to the support arms 19 and 20.

This fixing element 34 is arranged on a part 35 (FIG. 7) of the base body 18, to which also release yokes 36 and 37 are formed in one part. The part 35 is arranged on the base body 18 to allow of bending, so that a fixed state of the contact connector 32 can be released again by means of the fixing element 34 being capable of being moved downwards in the direction of the arrow P1 by taking hold of and pushing downwards the release yokes 36 and 37.

As is besides shown in FIG. 7, the base body 18 comprises an insertion slot 38, into which a further retaining bracket 39 (FIG. 10), which is also formed in one piece to the wall 8, is inserted in the end position.

In FIG. 8 a further perspective view of the carrier 15 with the separated contact connector 32 is shown. It can be recognised that behind the insertion slot 38 in the base body 18 an opening 40 is formed, which is upwardly and thus against the direction of the arrow P1 accessible. In the opening 40 also a receptacle 41 for a screw is provided, which can be screwed into a corresponding thread. The screw can here be slid through a hole in the retaining bracket so that an additionally improved position fixing of the mounted carrier 15 in its end position on the wall 8 is achieved.

In FIG. 9 an enlarged detail of the illustration in FIG. 8 is shown, in which, however, the contact connector 32 is shown in the mounted end position on the carrier 15. It can be seen that the ramp-shaped fixing element 34, which rises towards the contact connector 32, supports the contact connector 32. In mounting the contact connector 32, said contact connector 32 is pushed over the fixing element 34 and then snaps into place behind the fixing element 34 so that said fixing element 34 engages behind the contact connector 32 according to the illustration in FIG. 9.

In FIG. 10 the mounted end position of the carrier 15 on the wall 8 is shown and the mounted end position of the contact connector 32 on the carrier 15 illustrated. It is recognisable that in the wall 8 a hole 42 is formed, through which then the light emitted by the light sources can radiate into the space 4.

### LIST OF REFERENCE NUMBERS

1 household appliance
2 outer housing
3 inner container
4, 5 inner spaces
6 dividers
7 partition wall
8 top wall
9, 10 illuminating devices
11, 12, 13, 14 light sources
15 carrier
15a, 15b opposing sides
16 receiving space
17 circuit board
17a side edge
18 base body
19, 20 support arms
21 stiffening struts
22 edge limitation
23, 24 clasping elements
25, 26 retaining arms
27, 28 engagement slots
29, 30 retaining brackets
31 holding device
32 contact connector
33 receiving body
34 fixing element
35 part
36, 37 release yokes
38 insertion slot
39 retaining bracket
40 opening
41 receptacle
42 hole

1-15. (canceled)

16. An illuminating device for a household appliance, the illuminating device comprising:
a circuit board with at least one light source;
a carrier supporting said circuit board with said at least one light source, said carrier being formed as a fixing adapter for said circuit board on a wall of the household appliance.

17. The illuminating device according to claim 16, wherein said carrier is non-destructively detachably connected to the wall.

18. The illuminating device according to claim 16, wherein said carrier has a base body formed with retaining arms on opposing sides thereof, said retaining arms having engagement slots for engagement with retaining brackets of the wall.

19. The illuminating device according to claim 16, wherein said carrier has a base body formed with two support arms on a longitudinal side thereof, and wherein said support arms are spaced apart and oriented parallel to one another, and configured to support said circuit board.

20. The illuminating device according to claim 19, wherein said support arms have clasping elements that engage around an edge of said circuit board.

21. The illuminating device according to claim 16, wherein said carrier has a base body and a holding device formed on said base body for a contact connector for electrically connecting an electrical line with electrical contacts of said circuit board.

22. The illuminating device according to claim 21, wherein said holding device comprises a receiving body into which said contact connector is insertable, and at least one fixing element configured for positionally fixing the contact connector.

23. The illuminating device according to claim 22, wherein said fixing element is a ramp, wherein the contact connector is pushed over said ramp into an end position and said ramp engages behind the contact connector in the end position thereof.

24. The illuminating device according to claim 22, wherein said holding device includes release yokes configured to move said fixing element downwards from a fixing position and to move said fixing element into a release position to enable a removal of the contact connector.

25. The illuminating device according to claim 16, wherein said carrier has a base body formed with an insertion slot for receiving a retaining bracket of the wall.

26. The illuminating device according to claim 25, wherein said base body is formed with an opening behind said insertion slot, said opening is accessible from above for insertion of a fastening element to be moved into a receptacle in said retaining bracket.

27. The illuminating device according to claim 26, wherein the fastening element is a screw.

28. The illuminating device according to claim 16, wherein said carrier is formed in one piece and of plastic.

29. The illuminating device according to claim 28, wherein said carrier is formed of PBT.

30. The illuminating device according to claim 16, wherein said at least one light source is a light-emitting diode.

31. A household appliance, comprising walls defining an inner space for receiving foodstuffs, and at least one illuminating device according to claim 16 disposed to illuminate the inner space.

32. The household appliance according to claim 31 configured as a domestic cooling appliance.

33. The household appliance according to claim 31, wherein said illuminating device is mounted to a top wall defining the inner space.
